(19) United States
(12) Patent Application Publication
(10) Pub. No.: US 2021/0260903 A1
(43) Pub. Date: Aug. 26, 2021

(54) METHOD FOR PRODUCING A VIRTUAL THREE-DIMENSIONAL PATTERN IN A COATING

(71) Applicant: MERCK PATENT GMBH, DARMSTADT (DE)

(72) Inventors: Johannes TASCH, Muehlhausen (DE); Ruediger SMOLKA, Zwingenberg (DE); Peter CLAUTER, Pfungstadt (DE); Klaus-Christian ULLMANN, Bensheim (DE)

(73) Assignee: MERCK PATENT GMBH, DARMSTADT (DE)

(21) Appl. No.: 17/253,918

(22) PCT Filed: Jun. 17, 2019
(86) PCT No.: PCT/EP2019/065809

§ 371 Date: Dec. 18, 2020

(30) Foreign Application Priority Data
Jun. 19, 2018 (EP) 18178544.5

(51) Int. Cl. B41M 1/10; B41M 3/06; B41F 11/02; B44F 7/00

(52) U.S. Cl. CPC B41M 1/10; B44F 7/00; B41F 11/02; B41M 3/06

(57) ABSTRACT

The present invention relates to a gravure printing process for the production of a virtual three-dimensional pattern in a coating comprising flake-form effect pigments on a print substrate, to a coating produced in this way, and to the use thereof.

The present invention relates to a gravure printing process for the production of a virtual three-dimensional pattern in a coating, in particular for the production of a directly visible pattern which clearly appears three-dimensional in a coating comprising flake-form effect pigments on a print substrate, to a coating produced by a process of this type, and to the use of a coating of this type, preferably for the production of decoration materials, such as magazines, catalogues, brochures, advertising materials, calendars, book covers, labels or tickets, and of packaging materials, works of art or security products.

Decorative coatings containing three-dimensional patterns on wallpapers, furniture decoration films or packaging materials are known and are preferably employed for relatively high-value goods or luxury packaging, since they provide the end products in them with a particular aura. For this purpose, the corresponding substrates and/or the coatings applied thereto are frequently structured in such a way that they have a tactile, three-dimensional surface structure. This effect is often very desired in order also to provide, for example, furniture decoration films having a wood grain with a corresponding feel in addition to the wood-like appearance. Structuring of this type is generally carried out via complex embossing processes, which, however, require high equipment complexity and increased production costs. If the desired three-dimensional patterns are also intended to have special effects, such as metallic effects or pearlescence, coating and embossing methods which can also be employed without loss of quality in the case of coatings which comprise corresponding effect pigments or consist of vapour-deposited effect layers are additionally necessary.

The prior art discloses structuring processes by means of which substrates can be provided with three-dimensional patterns. Thus, for example, EP 0 115 038 discloses a process for the production of coloured decoration paper films in which the films are provided with a three-dimensional surface structure by providing a first print layer, which comprises a release agent and has a pattern, with an overvarnish. The release agent leads to thickness differences in the overvarnish, which ultimately produce an optically and haptically perceptible three-dimensional pattern. The use of flake-form effect pigments is not described.

WO 2012/079674 by the present applicant discloses a process for the production of three-dimensional patterns in a coating, in which a coating comprising flake-form effect pigments which has not yet cured on a substrate is brought into contact with a flexographic printing plate in such a way that recesses having a depth of at most 10 μm are formed on the surface of the coating. The coating minimally deformed in this way is subsequently cured. The said recesses, together with the unembossed surface units, form a pattern having a three-dimensional appearance in the coating, which exhibits significantly more visible three-dimensionality than would be expected from the actual deformation of the coating. However, it has been found that it is relatively difficult to incorporate this process into existing printing lines, since two printing machines are necessary to produce the three-dimensional pattern. It would therefore be desirable to have available a process for the generation of similar effects which leads to comparable results in only a single printing operation and could preferably be carried out in the gravure printing process, which is widely employed worldwide.

The object of the present invention therefore consists in providing a process for the production of a pattern having a three-dimensional appearance in a coating on a substrate, in which neither the substrate nor the coating has to be embossed or deformed for the formation of an attractive pattern having a three-dimensional appearance in the coating, the pattern is produced in a single printing operation and the process can be carried out as gravure printing.

A further object of the invention consists in providing a coating comprising flake-form effect pigments which has the previously generated pattern having a three-dimensional appearance, on a substrate.

An additional object of the present invention consists in indicating a use for coatings produced in this way.

The object of the present invention is achieved by a process for the production of a virtual three-dimensional pattern in a coating on a print substrate, in which
cells and/or hachures located on a surface of a gravure printing plate
are filled with printing ink and subsequently
the printing ink is transferred to a print substrate and solidified, where
the printing ink comprises flake-form effect pigments and
a first type of cells and/or hachures which have a flat base and side flanks, where the base is aligned parallel to the surface of the gravure printing plate and the flanks have an inclination angle α in the range from 70° to 90°, relative to the base, and
a second type of cells and/or hachures which have a flat base and side flanks, where the base has an inclination angle β, relative to an imaginary base line running parallel to the surface of the gravure printing plate, that is smaller than the inclination angle of the flanks of the first type of cells and/or hachures, are arranged on the surface of the gravure printing plate, and
where the first and second types of cells and/or hachures are arranged alongside one another, at least on a part-area of the surface of the gravure printing plate, with formation of boundary regions.

The object of the present invention is also achieved by a coating comprising flake-form effect pigments on a print substrate, which coating has a visible, virtual three-dimensional pattern formed by orientation of the flake-form effect pigments in the coating at various angles, relative to the print substrate. The coating has a planar, unembossed surface.

Furthermore, the object is also achieved by the use of a coating of this type in decoration materials, packaging materials, works of art and security products.

The process according to the invention is a conventional gravure printing process which is carried out with specially adapted gravure printing plates and with printing inks comprising flake-form effect pigments.

Conventional gravure printing plates are provided with cells and/or hachures which represent recesses in the surface of the printing plate and, during the printing operation, are firstly filled with printing ink, which is subsequently transferred directly out of the cells and/or hachures onto a print substrate, where it is solidified. A gravure printing process is accordingly a direct printing process in which the amount of printing ink transferred to the print substrate is determined by the volume of the cells and/or hachures. The cells and/or hachures are arranged on the surface of gravure printing plates. Cells are small recesses having, in plan view, a round or polygonal base shape, which are arranged in rasters on a printing plate and can be varied in the shape of the cell base and in their width and depth. The shape of the cell base is dependent on the type of cell engraving. Cells are known which have spherical bases, flat bases or a base which has the shape of an inverted pyramid with variable edge lengths. Suitable printing plates for printing with gravure printing inks comprising flake-form effect pigments are, in particular, those which have cells with a spherical or flat base. The cells are separated on the printing plate by lands and have side flanks, which usually have an inclination angle, relative to a flat base line, in the range from 70° to 90°. The inclination angle here is not identical with the so-called opening angle of the cell, which can be defined by means of the cell opening arising between the side flanks.

Hachures are line engravings which frequently run around a print roller in a continuous line. They can be arranged at various angles on the surface of the printing plate. In hachures, the width and depth of the line engravings can also be adjusted. The base is usually formed flat and aligned parallel to the surface of the gravure printing plate. The side flanks of the hachures generally likewise have an inclination angle in the range from 70 to 90°, relative to a flat base line running parallel to the surface of the gravure printing plate.

The printing plates employed in the printing process according to the invention are gravure printing plates or gravure printing cylinders, but preferably gravure printing cylinders. Cells and/or hachures are arranged on the surface of the printing plates. In accordance with the invention, the cells and/or hachures arranged on the printing plate employed consist of two types, which are arranged alongside one another, at least on a part-area of the surface of the gravure printing plate, in such a way that they form boundary regions. The boundary regions here are preferably formed as continuous lines with a length of at least 2 mm and in particular at least 5 mm. In accordance with the invention, these lines form at least part of the outer contour of virtually three-dimensional print motifs which can be produced using the process according to the invention.

In accordance with the invention, the first type of cells and/or hachures on the gravure printing plate have a flat base and side flanks, where the base is aligned parallel to the surface of the gravure printing plate and the flanks in each case have an inclination angle in the range from 70° to 90°, relative to the base. This inclination angle is referred to as a below. In principle, the first type of cells and/or hachures thus corresponds to the cells and/or hachures usually employed in gravure printing plates. They are arranged in rasters and can extend over the majority of the surface of the printing plate.

The second type of cells and/or hachures arranged on the surface of the gravure printing plate likewise has a flat, i.e. planar, base and side flanks, but the base is not arranged parallel to the surface of the gravure printing plate, but instead has an inclination angle relative to an imaginary base line running parallel to the surface of the gravure printing plate (and set at the lowest point of the cell or hachure), which is referred to as β below. In accordance with the invention, the inclination angle β is smaller than the inclination angle α of the flanks of the first type of cells and/or hachures. In particular, the inclination angle β is at least 30 degrees smaller than the inclination angle α and is thus smaller than 60°, preferably smaller than 40°. In particular, the inclination angle β is in the range from 4 to 30°, particularly preferably from 5 to 20°. The base can be provided with an inclination on one side or both sides. In the latter case, the base is in two parts, where the two parts can have different sizes. The cell and/or hachure is thereby in each case divided on the long side into two parts with base parts aligned in opposite directions, which form a groove where they run together at the lowest point of the base. The inclination of the base preferably runs away from the boundary region, i.e. the boundary line between the first and second types of cells and/or hachures, or is formed towards the boundary region on both sides in longitudinal alignment.

According to the present invention, the cells of the first and second types preferably have a polygonal base shape, in particular a rectangular or square base shape, which is visible on the printing plate in plan view. Accordingly, each cell preferably has four side flanks.

Depending on the width of the cells or hachures employed for the second type in combination with the respective maximum depth and selected inclination angle β, there are, however, also embodiments of the present invention in which one of the four side flanks of a cell or one of the two side flanks of a hachure is omitted. This happens in the case of a low maximum depth, large width and comparatively steep inclination angle β in the above-mentioned range. In these cases, the side flank is in practice replaced by the inclined base of the cell or hachure of the second type. The remaining side flanks of the cells and/or hachures of the second type preferably likewise have an inclination angle α in the range from 70° to 90°.

The second type of cells and/or engravings is also arranged in rasters on the gravure printing plate.

As already described briefly above, in the process according to the invention cells and/or hachures of the second type are arranged on the gravure printing plate alongside the cells and/or hachures of the first type in such a way that boundary regions are formed between the two types. Cells of the first type can be arranged alongside cells of the second type, hachures of the first type can be arranged alongside hachures of the second type, cells of the first type can be arranged alongside hachures of the second type or hachures of the first type can be arranged alongside cells of the second type, or a combination of at least two of the said arrangements may also be present on the gravure printing plate. The respective cells and/or hachures are separated in each case by lands both within a type and also between the two types.

Boundary regions which are formed by the cells and for hachures of the two types lying alongside one another are, in accordance with the invention, continuous lines having a minimum length of 2 mm. It goes without saying here that the first type of cells and/or hachures are arranged on one side of the line and second type of cells and/or hachures are arranged on the other side of the line, so that an actual boundary line is detectable (possibly only under the microscope) on the printing plate. This means that, for example in the case of a perpendicular boundary line, in each case one type of cells and/or hachures are arranged on the left-hand side of the printing plate immediately adjacent to the boundary line and the other type of cells and/or hachures are arranged on the right-hand side of the printing plate immediately adjacent to the boundary line. It should be emphasised here that the boundary line is formed exclusively by the difference between the two different types of cells and/or hachures and does not represent an additional engraving.

In accordance with the invention, the second type of cells and/or hachures has a greater maximum depth than the first type of cells and/or hachures, where the maximum depth of the second type of cells and/or hachures is measured at the deepest point of the base, whereas the depth of the first type of cells and/or hachures represents the actual depth of the flat base (parallel to the surface of the gravure printing plate).

The maximum depth of the second type of cells and/or hachures is, in accordance with the invention, 40 μm and is preferably in the range from 10 to 40 μm.

The ratio of the maximum depth of the second type of cells and/or hachures to the depth of the first type of cells and/or hachures is, in accordance with the invention, in the range 1.1:1 to 2.0:1, preferably in the range from 1.3:1 to 1.7:1.

The width of the cells and/or hachures of the first and second types, which, arranged alongside one another, in each case form a boundary region, may be identical or different. It is preferably different. In particular, the width of the first type of cells and/or hachures is greater than the width of the second type of cells and/or hachures. A ratio of 1.1:1 to 1.5:1 is advantageously set here.

The width of the cells and/or hachures of both types is in the range from 70 to 100 μm, while the depth of the first type of cells and/or hachures is in the range from 5 to 36 μm, in particular from 5 to 25 μm.

For both types of cells and/or hachures, screen counts in the range from 40 to 150 lines/cm can be employed.

From the size ratios of the two types of cells and/or hachures, which, arranged alongside one another, in each case form a boundary region, it arises that the printing ink transferred to the print substrate by means of the first type of cells and/or hachures has a volume per area unit that is smaller than the volume per area unit transferred to the print substrate by means of the second type of cells and/or hachures.

The volume per area unit transferred to the print substrate by means of the second type of cells and/or hachures is at least 5 ml/m² and at most 20 ml/m².

The ratio of the transferred volumes of printing ink from first to second type of cells and/or hachures is advantageously in the range from 1:1.2 to 1:2.

The boundary regions formed by the arrangement alongside one another of cells and/or hachures of the first type and cells and/or hachures of the second type are preferably formed as continuous lines with a minimum length of 2 mm. These continuous lines form at least part of the contours of print motifs which appear virtually three-dimensional on the print substrate after the printing ink has been transferred and solidified. The boundary regions preferably form the entire contour line of the print motifs which are intended to appear virtually three-dimensional on the print substrate. The flat inclination angle of the base of the cells and/or hachures of the second type forces alignment of the flake-form effect pigments along the inclined base of these cells and/or hachures as soon as they are filled with the corresponding printing ink. This alignment is retained in the printing ink transferred to the print substrate until it has solidified. Since such an alignment of the flake-form effect pigments does not occur in the cells and/or hachures of the first type, a different orientation of the flake-form effect pigments on the print substrate, relative to the surface of the print substrate, arises in the above-mentioned boundary regions, which are not formed only on the gravure printing plate, but also in the final print image on the print substrate. The boundary regions on the print substrate form exclusively via the different orientation of the flake-form effect pigments on both sides of the directly adjacent boundary regions.

The print motifs transferred to the print substrate and solidified represent regularly or irregularly shaped area elements having a size of at least 4 mm². They are surrounded at least partly and preferably completely by the outer contour lines described above and appear themselves as raised area elements, while a virtually three-dimensional appearance of these area elements is generated at the contour lines. This arises merely through the forced different orientation of the flake-form effect pigments on the print substrate.

In order to ensure retention, after the printing operation has taken place, of the forced alignment of the flake-form effect pigments present in the printing ink with which the second type of cells and/or hachures on the printing plate is filled, comparatively rapid solidification of the printing ink is advantageous. For this reason, radiation-curing and/or thermally curing printing inks can preferably be employed.

In particular, curing of the printing ink by UV radiation is preferred.

The binder systems of the printing ink vehicles to be employed should be selected correspondingly. All commercially available fast-curing printing ink vehicles can be employed here, in particular UV-curing printing ink vehicles, which, besides the corresponding binder systems, may additionally also comprise conventional additives, such as fillers, non-flake-form coloured pigments or dyes, inhibitors, flame retardants, lubricants, dispersants, redispersants, antifoams, flow-control agents, film formers, adhesion promoters, drying accelerators, photoinitiators, etc., or these can be added thereto.

Besides the printing-ink vehicle and possible further additives, the printing inks to be employed comprise flake-form effect pigments. The specific type of flake-form effect pigments or optionally mixtures of various effect pigments is determined here by the desired optical effects of the resultant pattern having a three-dimensional appearance in the coating and optionally also by colourants which may optionally already be present in any pre-coatings located on the print substrate.

Flake-form effect pigments which can be employed in the printing ink to be employed in accordance with the invention are pigments which are selected from the group pearlescent pigments, interference pigments, metal-effect pigments, liquid-crystal pigments, flake-form functional pigments, flake-form structured pigments, or a mixture of two or more thereof.

These effect pigments are built up from one or more layers of optionally different materials and are in flake form. Pigments or support materials are referred to as flake form if their outer shape corresponds to a two-dimensional structure which, with its upper and lower sides, has two surfaces approximately parallel to one another whose length and width dimension represents the greatest dimension of the pigment or support material and is also referred to as particle size. The separation between the said surfaces, which represents the thickness of the flake, has, by contrast, a smaller dimension.

These pigments preferably have a flake-form support, which optionally comprises at least one coating of a metal, metal oxide, metal oxide hydrate or mixtures thereof, a metal mixed oxide, suboxide, oxynitride, metal fluoride or a polymer.

Pearlescent pigments consist of transparent flakes of high refractive index and exhibit a characteristic pearlescence due to multiple reflection in the case of parallel orientation. Pearlescent pigments of this type which additionally also exhibit interference colours are known as interference pigments.

Although classical pearlescent pigments, such as TiO₂ flakes, basic lead carbonate, BiOCl pigments or nacreous pigments, are naturally also suitable in principle, the effect pigments employed for the purposes of the invention are preferably flake-form interference pigments or metal-effect pigments, which have at least one coating of a metal, metal oxide, metal oxide hydrate or mixtures thereof, a metal mixed oxide, metal suboxide, metal oxynitride, metal fluoride or a polymer on a flake-form support.

The metal-effect pigments preferably have at least one metal support or a metal layer.

The flake-form support preferably consists of natural or synthetic mica, kaolin or another phyllosilicate, glass, calcium aluminium borosilicate, SiO₂, TiO₂, Al₂O₃, Fe₂O₃, polymer flakes, graphite flakes or metal flakes, such as, for example, of aluminium, titanium, bronze, silver, copper, gold, steel or diverse metal alloys.

Particular preference is given to flake-form supports comprising mica, glass, calcium aluminium borosilicate, graphite, SiO₂, Al₂O₃ or aluminium.

The size of the flake-form support substantially determines the size of the effect pigments and must be selected specifically for the process according to the invention, since flake-form effect pigments having a large particle size are only able to achieve the desired orientation to an inadequate extent. In accordance with the invention, the length or width dimension of the flake-form support is therefore from 1 to 60 μm, preferably from 1 to 25 μm and in particular from 1 to 15 μm. The supports generally have a thickness between 0.05 and 4.5 μm and particularly preferably from 0.1 to 1 μm. They have an aspect ratio (ratio of the average diameter to the average particle thickness) of 2:1 to 1000:1 and in particular of 6:1 to 250:1.

The said dimensions for the flake-form supports in principle also apply to the coated effect pigments used in accordance with the invention, since the additional coatings are generally in the region of only a few hundred nanometres and thus do not significantly influence the thickness or length or width (particle size) of the pigments.

A coating applied to the support preferably consists of metals, metal oxides, metal mixed oxides, metal suboxides or metal fluorides and in particular of a colourless or coloured metal oxide selected from TiO₂, titanium suboxides, titanium oxynitrides, Fe₂O₃, Fe₃O₄, SnO₂, Sb₂O₃, SiO₂, Al₂O₃, ZrO₂, B₂O₃, Cr₂O₃, ZnO, CuO, NiO or mixtures thereof.

Metal coatings preferably comprise aluminium, titanium, chromium, nickel, silver, zinc, molybdenum, tantalum, tungsten, palladium, copper, gold, platinum or alloys thereof.

The metal fluoride employed is preferably MgF₂.

Particular preference is given to effect pigments which have a flake-form support comprising mica, glass, calcium aluminium borosilicate, graphite, SiO₂, Al₂O₃, or comprising aluminium and at least one coating on the support selected from TiO₂, titanium suboxides, titanium oxynitrides, Fe₂O₃, Fe₃O₄, SnO₂, Sb₂O₃, SiO₂, Al₂O₃, MgF₂, ZrO₂, B₂O₃, Cr₂O₃, ZnO, CuO, NiO or mixtures thereof.

The effect pigments can have a multilayered structure in which a plurality of layers, which preferably consist of the above-mentioned materials and have different refractive indices in such a way that in each case at least two layers of different refractive index are located alternately on the support, are located one above the other on a metallic or non-metallic support, where the refractive indices in the individual layers differ from one another by at least 0.1 and preferably by at least 0.3. The layers located on the support can be either colourless or coloured, predominantly transparent, semi-transparent or even opaque.

Depending on the support material used and the type of layers applied, the effect pigments obtained are thus also colourless or have a mass tone, or are predominantly transparent, semi-transparent or opaque. Due to the single- or multilayered system on the support, however, they are additionally capable of generating more or less intense and glossy interference colours.

The so-called LCPs (liquid crystal pigments), which consist of crosslinked, oriented, cholesteric liquid crystals, but also polymer or metal flakes known as holographic pigments, can likewise be employed as effect pigments.

The effect pigments described above may be present individually or as a mixture of two or more in the printing ink employed in accordance with the invention. They can likewise be employed in a mixture with organic and/or inorganic dyes or coloured pigments and/or also in mixtures with uncoated mica. The proportion by weight of the flake-form effect pigments in the printing ink is generally between 1 and 15 percent by weight and preferably between 1 and 10 percent by weight, in each case based on the total weight of the printing ink employed. If they are employed in a mixture with non-flake-form pigments, the content of flake-form effect pigments in the printing ink is, however, preferably higher than the content of these other pigments in order that the desired orientation of the flake-form effect pigments in the coating on the print substrate is not hindered. For this purpose, the proportion of flake-form effect pigments should correspond to at least 50% by weight, but preferably at least 70% by weight of the total pigment loading of the printing ink.

Flake-form effect pigments which can be employed are, for example, the commercially available functional pigments, interference pigments or pearlescent pigments available under the names Iriodin®, Colorstream®, Xirallic®, Miraval®, Ronastar®, Biflair®, Minatec®, Iriotec®, Lustrepak®, Colorcrypt®, Colorcode® and Securalic® or Meoxal® from Merck KGaA, Mearlin® from Mearl, metal-effect pigments from Eckart and optically variable effect pigments, such as, for example, Variochrom® from BASF, Chromafflair® from Flex Products Inc., Helicone® from Wacker, holographic pigments from Spectratec and other commercially available effect pigments.

The individual colour and/or lustre effects which can be achieved by the effect pigments are not crucial per se for the success of the present invention. Rather, the success according to the invention is achieved by the change in the optically perceptible effect of the flake-form effect pigments at the boundary regions in the coating on the substrate, in which the flake-form effect pigments orientate themselves differently relative to the surface of the print substrate. At these boundary regions or boundary lines, the flake-form effect pigments in the printing ink are aligned very substantially parallel to the surface of the substrate if they are transferred to the print substrate by the first type of cells and/or hachures, and are aligned at an angle to the surface of the substrate if they are transferred to the print substrate by the second type of cells and/or hachures. The angle at which the flake-form effect pigments are aligned to the surface of the substrate is determined here by the inclination angle β, without corresponding to this.

The three-dimensional pattern visible in the coating is therefore only perceptible on the print substrate via the optical effects rendered visible by the effect pigments. It is significantly more pronounced here than the actual deflection of the flake-form effect pigments in the boundary regions would suggest, since a deflection of the flake-form effect pigments out of the parallel position, even by only a few angle degrees, already has the consequence of a significant change in their reflection properties, which is evident optically as apparent depth of the pattern having a three-dimensional appearance. The term virtual three-dimensional pattern for the pattern produced in accordance with the invention is therefore justified.

However, preference is of course given to the use of effect pigments with which it is possible to achieve optically very attractive print results which cannot be obtained with classical organic or inorganic dyes or coloured pigments alone. Thus, in particular in packaging printing, intense lustrous interference colours, metallic effects or print images which exhibit a colour play and/or impressive light/dark effects on tilting (optically variable prints) are very desirable. Such colour and lustre impressions can only be achieved with flake-form effect pigments.

If the flake-form effect pigments employed exhibit an optically variable behaviour, this is of course perceptible in the patterned coating produced in accordance with the invention not only if the viewing angle is changed relative to the entire coated surface, but also even on viewing of the surface of the coated print substrate from a single viewing angle, so that the three-dimensional pattern generated appears in various colours and/or various brightness shades.

The print substrates employed are conventional substrates which can be coated using conventional gravure printing processes, for example paper of a wide variety of qualities, cardboard, wallpapers, laminates, plastic films, metal foils, or materials which contain constituents comprising a plurality of these substances. The print substrates may optionally have been pretreated electrostatically or by application of primer or satinisation layers.

The surface to be coated on the print substrates employed should be flat, i.e. have neither bumps nor depressions. In addition, it has been found that print substrates which have a particularly smooth surface are especially suitable for the process according to the invention. In particular, plastic films, metal foils, precoated papers and cardboard or laminates which contain these can therefore advantageously be employed.

Conventional primer or satinisation layers often have a pale or white colouration. Print substrates precoated in this way are suitable per se as print substrates for use in the process according to the invention, but the effects having a three-dimensional appearance that can be achieved therewith in the coating are subtle and not perceptible to a very pronounced extent.

The print substrates therefore preferably have a black, dark or coloured surface. This colouration of the print substrate can, depending on the material employed and intended use of the finished product, be obtained either by mass coloration of the print substrate material, for example in the case of plastic films, or by means of coating of the print substrate with a black, dark or coloured coating. The latter can be applied in addition or as an alternative to primer or satinisation layers. A dark coating is taken to mean, for example, grey, brown, blue, red, violet or green coatings which have only low brightness, i.e. are generally referred to as dark grey, dark brown, dark blue, dark red, dark violet or dark green. They can be obtained, in exactly the same way as coloured coatings, by addition of conventional colourants to corresponding coating compositions, optionally in combination with carbon black or other black colourants. The entire print substrate surface to be coated is preferably provided with a black, dark or, alternatively, coloured coating of this type.

In addition to a satinisation or primer layer and/or black or dark colouring of the print substrate or also as an alternative thereto, the print substrate can also be precoated over the entire area by means of conventional printing processes or provided with a pattern before use in the process according to the invention. This precoating can be carried out using any desired printing process. The colour or pattern effects generated can advantageously be combined with the virtual three-dimensional pattern generated in the process according to the invention.

The print substrate can be coated over the entire area or in part-areas with the coating comprising the flake-form effect pigments which has been produced in the gravure printing process according to the invention, where at least some of the part-areas and preferably each of the part-areas has at least one boundary region described above having a minimum length of 2 mm.

Area elements having a size of at least 4 mm² which have an outer contour line formed at least in part from the boundary regions or boundary lines described above are generated on the print substrate by means of the process according to the invention. The area elements applied may already represent a pattern as individual elements and/or the totality or parts of the area elements may represent a pattern with one another. The type of pattern is unimportant here, it can be, for example, an abstract pattern, a random pattern, a dot or line pattern, an alphanumeric pattern, a pattern comprising specific objects or a combination of two or more thereof. The pattern is present on the surface of the print substrate in regular, irregular or random distribution and may either be restricted to a part-region of the print substrate, i.e., for example, located in the centre, or else may be present extended over the entire surface of the print substrate.

In accordance with the invention, it is important that the area elements, the contour lines surrounding them, which correspond to the above-mentioned boundary regions, and the regions adjacent to the contour lines, which are intended to be applied to the print substrate are in each case coated with the printing ink comprising the flake-form effect pigments, since the forced inclined alignment of the effect pigments takes place at the contour lines and consequently the desired virtual three-dimensional effect is generated in the pattern of the coating.

It goes without saying that specification of a maximum area of the area elements is not appropriate, since this is dependent on the size of the print substrate and the size of the printing plate and on the desired print motifs and may easily also have a size of several hundred square centimetres, although the virtual three-dimensional effect that can be achieved therewith is readily visible in such a case.

The area elements in the solidified state have a layer thickness in the range from 1 to 10 μm, in particular from 3 to 8 μm. At these layer thicknesses of the solidified coating, the virtual pattern having a three-dimensional appearance generated in accordance with the invention in the coating is clearly visible and optically attractive.

In addition to flake-form effect pigments, the printing ink to be employed in the process according to the invention comprises at least one binder. In addition, the printing ink may also comprise the usual assistants and additives.

Suitable binders are, in particular, the usual radiation-curing binders or binder systems that are generally employed in radiation-curing gravure printing inks, in particular UV gravure printing inks. The corresponding compositions for the printing ink vehicles are known to the person skilled in the art and are commercially available. The correspondingly suitable coating compositions can be selected depending on the technological, qualitative or equipment-related requirements of the respective user.

Preference is given to the use of UV-curing inks, since these can be cured very rapidly. Particularly suitable in accordance with the invention are UV printing inks having a viscosity of 35 to 45 sec., determined, for example, in accordance with DIN EN ISO 2431 in a 4 mm flow cup at 23° C.

The printing ink is applied to the print substrate at a speed of 10 to 200 m/min, preferably 10 to 100 m/min. The achievable virtual three-dimensional effect in the pattern on the coating is better, the greater the time separation between the application of the printing to the print substrate and its solidification.

After the application of the printing ink comprising the flake-form effect pigments to the print substrate, the patterned print layer formed in this way is solidified. The solidification is achieved by drying and optionally curing of the print layer by means of UV radiation, where the formation of a virtual three-dimensional effect can advantageously be supported, if required, by the prior supply of heat, for example by hot air or IR radiation. The corresponding specific measures depend on the type of coating compositions employed in each case.

A single-layered print image, which has a surface arranged parallel to the surface of the print substrate and has a planar outer surface, is obtained on the optionally precoated print substrate. The virtual, three-dimensional pattern that is visible from the surface side of the coated print substrate is generated merely by the alignment of the flake-form pigments in the printing ink. This alignment takes place in the boundary regions of the area elements at various angles relative to the surface of the print substrate.

The present invention also relates to a coating which comprises flake-form effect pigments and has a visible, virtual three-dimensional pattern, on a print substrate, where the virtual three-dimensional pattern is formed by orientation of the flake-form effect pigments in the coating at various angles, relative to the print substrate, and the coating has been produced by the process described above.

Details in relation to the material composition of the print substrates which can be employed, the printing ink, and in relation to the suitable flake-form effect pigments have already been explained in detail above.

The visible, virtual three-dimensional pattern in the coating according to the invention is, as already mentioned, generated exclusively by the orientation of the flake-form effect pigments present in the printing ink at various angles, relative to the surface of the print substrate. The reflection behaviour of the effect pigments, which is modified by the non-parallel alignment of the flake-form effect pigments in the boundary regions of the area elements, considerably reinforces the optically perceptible three-dimensional effect. Neither the print substrate nor the coating applied thereto is three-dimensionally deformed. In particular, the coating has a planar surface.

The virtual three-dimensional pattern present in accordance with the invention in the coating represents a macroscopic pattern, where the individual area elements visible in the coating have a size of at least 4 mm², in particular of at least 10 mm², but may also have sizes of several hundred square centimetres. The size and outer shape of the visible area elements having a three-dimensional appearance is directly dependent on the size and outer shape of the area elements formed on the gravure printing plate by the arrangement of cells and/or hachures of the first type and replicates these.

The present invention also relates to the use on a print substrate of a coating comprising flake-form effect pigments which has a virtual, three-dimensional pattern and has been produced by the process described above.

Since the process described above, due to the use of an industrially widespread gravure printing process, is particularly suitable for the production of mass-produced products, the use of the coatings produced in this way in decoration materials, packaging materials, works of art or security products is of particular economic advantage.

Decoration materials are intended to be taken to mean all applications which are distinguished by particular optical effects, for example job-printed materials, calendars, decorative notepaper, advertising materials, greetings cards, offprints, wallpapers, but also tickets, magazines, catalogues, brochures, book covers, labels, decorative papers for furniture and flooring laminates and many more. Such products can experience a great increase in value due to the attractive virtual three-dimensional effect generated by means of the process according to the invention, since they simultaneously also exhibit the lustre effects and also any optically variable properties of the flake-form effect pigments employed.

The same applies to packaging materials of any type and to security products, which, besides functional features, are also intended to exhibit optically readily perceptible effects of high attractiveness.

Since the coatings having a virtual three-dimensional pattern which have been produced in accordance with the invention may also generate optical illusions, they can also advantageously be employed for the production of works of art.

Overall, the coatings having a virtual three-dimensional pattern which have been produced in accordance with the invention have an apparent optical depth of the visible three-dimensional pattern and the optical advantages of coatings comprising flake-form effect pigments. Neither the print substrates employed nor the coatings have to undergo embossing or deformation for this purpose. In addition, they can be generated in an economical manner in standard gravure printing processes without particular additional expenditure on machinery. The coatings according to invention are therefore highly suitable for the production of products of a wide variety of types having a high-value appearance with the aid of simple and conventional process steps as mass-produced products.

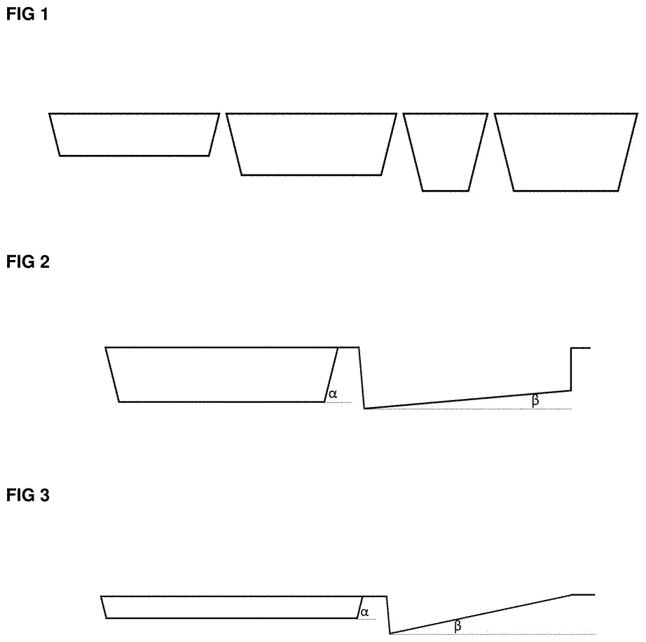

FIG. 1: shows diagrammatic representations of the cross sections of cell pairs of gravure printing plates in accordance with the prior art;
left: depth-variable cell pair,
right: area-variable cell pair

FIG. 2: shows a diagrammatic representation of the cross sections of cells and/or hachures in accordance with the invention arranged alongside one another;
left: cell or hachure of the first type,
right: cell or hachure of the second type

FIG. 3: shows a diagrammatic representation of the cross sections of a further variant of cells and/or hachures in accordance with the present invention arranged alongside one another;
left: cell or hachure of the first type,
right: cell or hachure of the second type

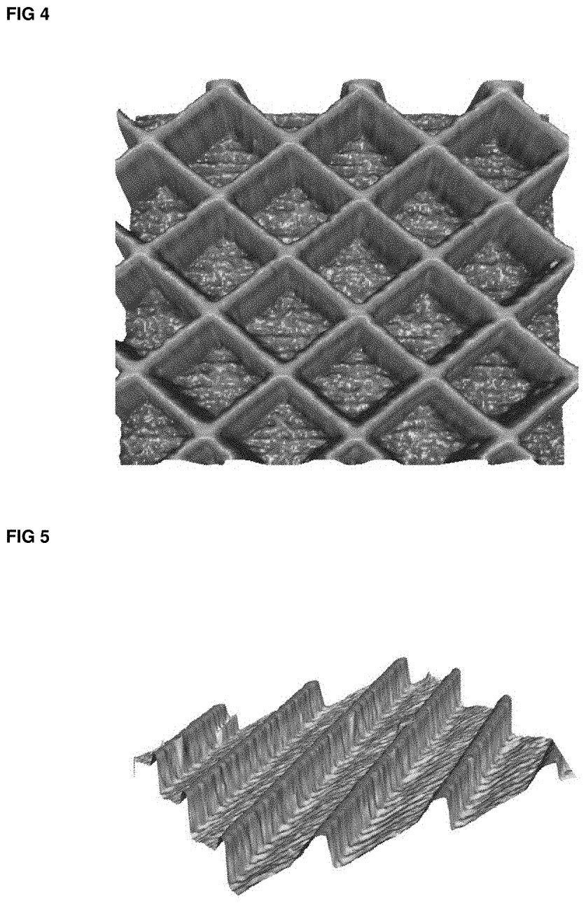

FIG. 4: shows an enlarged photograph of a 3D surface profile of cells of the first type in accordance with the present invention (not true to scale)

FIG. 5: shows an enlarged photograph of a 3D surface profile of hachures of the second type in accordance with the present invention (not true to scale)

The present invention will be explained in greater detail below with reference to an example, but is not intended to be reduced thereto.

### EXAMPLE 1

A printing ink comprising 95% by weight of a gravure printing varnish (Schmid Rhyner UV-Lack Wessco 3741) and 5% by weight of a flake-form effect pigment (Iriodin® 6111 Icy White Pristine KU26) is prepared. The printing ink has a viscosity of about 35 sec., determined using a DIN 4 cup. The printing ink is printed onto a paper coated on one side (Sappi Algro Finess 70 g/m²) that has been precoated in black in advance over the entire area by conventional solvent gravure printing using a Moser Rototest gravure printing machine at a maximum printing speed of 70 m/min. The gravure printing cylinder used is a special cylinder which has been engraved with one type of cells (conventional) and one type of hachures (“second type” in accordance with the present invention), which are arranged alongside one another and form boundary lines with one another which form a checkered pattern which is visible to the naked eye. The conventional cells have a depth of 16 μm and a width of 135 μm with a flat cell base. The hachures have a maximum depth of 21 μm (measured at the lowest point of the base), a width of 110 μm and a flat base, where the base has on one side an inclination angle of 5°, relative to an imaginary flat base line at the lowest point of the base. After application of the printing ink to the print substrate, the printed print substrate with a still-wet print layer is exposed to air at a temperature of 80° C. between the printing machine and a UV dryer, which favours the formation of a readily visible 3D effect. The printed layer is subsequently dried by means of a conventional UV lamp. This gives a silvery white, glossy print image on a black background which has a readily visible, three-dimensional, macroscopic checkered pattern whose raised area parts are transferred by the conventional cells and whose three-dimensional appearance arises through contours formed at the boundary lines between conventional cells and special hachures.

1. Process for the production of a virtual three-dimensional pattern in a coating on a print substrate, in which
cells and/or hachures located on a surface of a gravure printing plate
are filled with printing ink and subsequently
the printing ink is transferred to a print substrate and solidified, where
the printing ink comprises flake-form effect pigments and
a first type of cells and/or hachures which have a flat base and side flanks, where the base is aligned parallel to the surface of the gravure printing plate and the flanks have an inclination angle α in the range from 70° to 90°, relative to the base, and
a second type of cells and/or hachures which have a flat base and side flanks, where the base has an inclination angle β, relative to an imaginary base line running parallel to the surface of the gravure printing plate, that is smaller than the inclination angle of the flanks of the first type of cells and/or hachures, are arranged on the surface of the gravure printing plate, and
where the first and second types of cells and/or hachures are arranged alongside one another, at least on a part-area of the surface of the gravure printing plate, with formation of boundary regions.

2. Process according to claim 1, characterised in that the boundary regions are formed as continuous lines which form at least part of an outer contour of virtually three-dimensional print motifs.

3. Process according to claim 2, characterised in that the virtually three-dimensional print motifs are regularly or irregularly shaped area elements having an area of at least 4 mm², where the area elements are at least partly surrounded by an outer contour line.

4. Process according to claim 3, characterised in that the area elements in the coating on the print substrate appear to be raised.

5. Process according to claim 1, characterised in that the inclination angle β is at least 30 degrees smaller than the inclination angle α.

6. Process according to claim 1, characterised in that the inclination angle β is in the range from 4 to 30°.

7. Process according to claim 1, characterised in that the second type of cells and/or hachures has a greater maximum depth than the depth of the first type of cells and/or hachures.

8. Process according to claim 1, characterised in that the second type of cells and/or hachures has a maximum depth of 40 μm.

9. Process according to claim 1, characterised in that the printing ink transferred to the print substrate by means of the first type of cells and/or hachures has a volume per area unit which is smaller than a volume of printing ink per area unit which is transferred to the print substrate by means of the second type of cells and/or hachures.

10. Process according to claim 8, characterised in that the volume per area unit transferred to the print substrate by means of the second type of cells and/or hachures is at least 5 ml/m² and at most 20 ml/m².

11. Process according to claim 1, characterised in that the printing ink is a UV radiation-drying gravure printing ink.

12. Process according to claim 1, characterised in that the flake-form effect pigments are selected from the group pearlescent pigments, interference pigments, metal-effect pigments, liquid-crystal pigments, flake-form functional pigments, flake-form structured pigments, or mixtures comprising these.

13. Process according to claim 1, characterised in that a black, dark or coloured substrate is employed.

14. Process according to claim 1, characterised in that the print substrate is coated over the entire area or in part-areas with the printing ink comprising flake-form effect pigments, where at least some of the part-areas has at least one boundary region in a length of at least 2 mm.

15. Process according to claim 1, characterised in that the print substrate is a plastic film, a metal foil, a laminate, a paper, a cardboard or a wallpaper, where the substrate has optionally been precoated.

16. Coating comprising flake-form effect pigments on a print substrate, which has a visible, virtual three-dimensional pattern formed by orientation of the flake-form effect pigments in the coating at various angles, relative to the print substrate, produced by a process according to claim 1.

17. Coating comprising flake-form effect pigments according to claim 16, where the virtual three-dimensional pattern is a macroscopic pattern and has area elements having a size of at least 4 mm².

18. Coating comprising flake-form effect pigments according to claim 16, characterised in that the coating has a planar outer surface.

19. A process for preparing decoration materials, packaging materials, works of art or security products which comprises incorporating a coating comprising flake-form effect pigments according to claim 16 therein.

20. Decoration materials, packaging materials, works of art or security products containing a coating comprising flake-form effect pigments according to claim 16.
